(19) United States
(12) Patent Application Publication
(10) Pub. No.: US 2008/0226774 A1
(43) Pub. Date: Sep. 18, 2008

(54) Confectionery Product

(76) Inventors: Yanjing Wang, Beijing (CN); Wenling Zhao, Beijing (CN); Yang Yu, Beijing (CN); Xia Xiao, Beijing (CN)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 10/568,276

(22) PCT Filed: Aug. 12, 2004
(86) PCT No.: PCT/CN2004/000938

§ 371 Date: May 28, 2008

(30) Foreign Application Priority Data
Aug. 15, 2003 (CN) 03153557.7

(51) Int. Cl. A23G 3/54

(52) U.S. Cl. 426/89

(57) ABSTRACT

A confectionery product having an integrated body portion, which comprises at least two distinct and discrete and discrete regions respectively containing physiologically acceptable sugar free sweetener bases, wherein each two adjacent regions respectively contain different sweetener bases, and at least one regions respectively and essentially contain different sugar free sweetener bases. Said distinct and discrete regions respectively and selectively contain physiologically acceptable plant extracts and flavors, and are adapted to provide multiple different taste profiles to attract consumers.

### CROSS-REFERENCE TO RELATED APPLICATIONS

This application claims priority to Patent Cooperation Treaty (PCT) Application No. PCT/CN2004/000938 filed Aug. 12, 2004, entitled, A CONFECTIONERY PRODUCT, which claims priority to Chinese Patent Application Serial No. 03153557.7 filed Aug. 15, 2003, all of the disclosure of which is hereby incorporated by reference in its entirety.

### FIELD OF THE INVENTION

The present invention relates to a confectionery product for health protection, and more particularly to a confectionery product having a multi-layer structure adapted for providing multiple different taste profiles and mouth feelings.

### BACKGROUND OF THE INVENTION

It becomes well known that sugar carries contributory effects to many diseases, such as diabetes, hypertension, coronary heart disease, arterial sclerosis and dental caries etc. Now the tendency is that more and more people prefer sugar free products for health protection purpose. Specially, it is necessary and important for those who suffer from foregoing illustrated diseases to reject the conventional confectionery products with sugar contained therein.

Presently, varieties of confectionery products for health protection available on the market are still not so sufficient to meet various demands for different tastes and flavors of different consumers. For example, some sugar free confectionery products, such as sugar free hard candies that are made of sugar substitutes, are normally lack of taste profiles resulting in a low attraction.

Multi-component confectionery products are known in the food industry field.

EP150,934A discloses a multi-layer chewing gum composition, wherein the separate layers have different gum base content so that they release flavors at different rates.

EP267,160A describes an edible article of at least two discrete body parts joined together in a single compression step.

U.S. Pat. No. 4,762,719A describes a cough drop with a hard candy outer shell and a powered centerfill. Both the outer shell and the centerfill composition comprise an active ingredient such as menthol and eucalyptus. The shell may further comprise a flavor such as cherry, lemon, orange, lime, etc.

WO9706695 discloses a confectionery product comprising a coolant composition and a flavor composition in distinct and discrete regions thereof, the coolant and flavor compositions being adapted to provide different release profiles.

However, the foregoing illustrated products are typically sugar-based composition, and the structure of the conventional product is still lack of variability. Therefore, it is an objective of the invention to provide an improved confectionery product for health protection to overcome and/or obviate the aforementioned problems.

### SUMMARY OF THE INVENTION

A main object of the present invention is to provide a confectionery product for health protection, which comprises an integrated body portion including multiple distinct and discrete regions that respectively provide different taste profiles and mouth feelings to attract consumers.

To obtain the object of the present invention, the present invention provides a confectionery product comprising an integrated body portion, which includes at least two distinct and discrete regions, wherein different regions of said distinct and discrete regions respectively contain different physiologically acceptable sweetener bases, either one region of said distinct and discrete regions contains a sweetener base that is different from that contained in an adjacent region or adjacent regions, at least one regions of said distinct and discrete regions respectively and essentially contain different sugar free sweetener bases, which is selected from a group consisting of Isomalt, Xylito, Mannitol, Lactitol, Maltitol and Sorbitol.

Because the confectionery product in according to the invention comprises at least two distinct and discrete regions, which respectively contain different physiologically acceptable sweetener bases, at least one region respectively and essentially contain sugar free sweetener bases, and different sweeteners respectively have different chemical and physical properties leading to different mouth feelings and taste profiles, so that the confectionery product of the invention is capable of providing multiple different taste profiles and mouth feelings to attract people.

Another object of the present invention is to provide a confectionery product having multiple distinct and discrete regions, which are respectively and selectively added with different plant extracts and flavors combinations to improve the taste and the nutrition value of the confectionery product.

A further object of the present invention is to provide a confectionery product having multiple distinct and discrete regions, which respectively have different sizes of crystal grains, each two adjacent regions having distinct and discreteive crystal grain sizes, so as to increase the variety of mouth feelings of the product.

Other objects, advantages and novel features of the invention will become more apparent from the following detailed description.

### BRIEF DESCRIPTION OF THE DRAWINGS

FIG. 1 is a bar chart.

### DETAILED DESCRIPTION

All ratios and percentages are by weight of finished confectionery product unless otherwise indicated.

A confectionery product for health protection purpose in according to the present invention generally comprises an integrated body portion including at least two distinct and discrete regions, which respectively contain different sweetener bases, less than 20% by weight of plant extracts, less than 2% by weight of physiologically acceptable flavors, physiologically acceptable colorants, moisture and other additives. Wherein at least one regions of said distinct and discrete regions respectively and essentially contain physiologically acceptable sugar free sweetener bases, which is selected from a group consisting of Isomalt, Xylito, Mannitol, Lactitol, Maltitol and Sorbitol.

A main feature of the present invention is that one sweetener base contained in one region of said distinct and discrete regions is different from that contained in an adjacent region or regions of said distinct and discrete regions, i.e. each two adjacent regions of said distinct and discrete regions contain different sweetener bases. For example, a first region of said distinct and discrete regions contains a Lactitol base, a second region adjacent to the first region contains a Maltitol base. Because different sweeteners respectively have different chemical and physical properties leading to relative different taste profiles and mouth feelings, therefore, multiple regions combined in one body portion and respectively containing different sweetener produce variously distinctive taste profiles and mouth feelings.

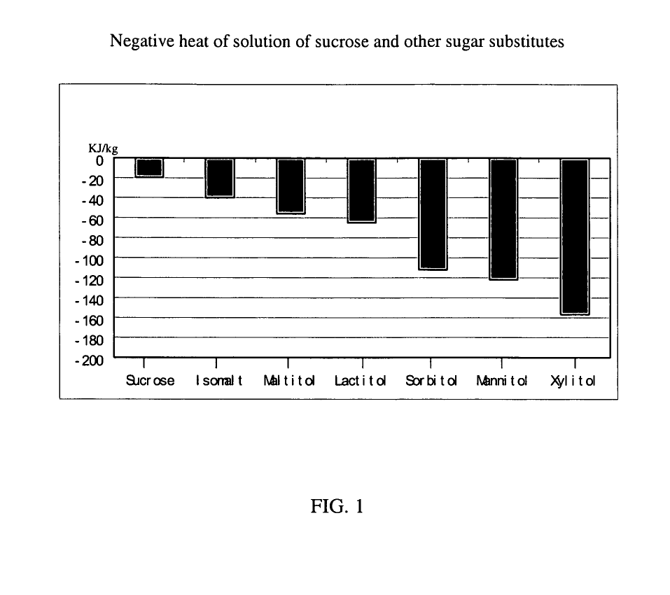

It is know in the food industry that some sweeteners, such as Isomalt, Xylito, Mannitol, Lactitol, Maltitol and Sorbitol, are suitable sugar substitutes. Additionally, it is known that these sugar substitutes have distinctively lower negative heat of solution than sugar, sucrose etc. FIG. 1 shows a comparison of negative heat of sucrose and other sugar substitutes. According to FIG. 1, the sucrose has a negative heat of solution about 20 KJ/kg, the Isomalt has a negative heat of solution about 40 KJ/kg, and the Xylitol has a negative heat of solution about 157 KJ/kg. The difference between different sweeteners is ranged from about 9 KJ/kg to about 137 KJ/kg. The different negative heat of solution leads to relatively distinct mouth feeling of temperature, whereby different cooling effects are obtained. When different sweeteners having negative heat of solution more than 9 KJ/kg are combined together, distinct mouth feelings of temperature are obtained.

Said distinct and discrete regions further respectively and selectively contain less than 20% by weight of plant extracts, such as bitten mellon extract, chrysanthemum extract, honey suckle extract, Luo Han Guo extract etc. Said plant extract or combination of plan extracts can be added into one region or multiple regions of said distinct and discrete regions, so as to improve the nutrition and taste profiles of the product. For example, extracts of bitten mellon, chrysanthemum and honey suckle have a benefit for “clearing heat” such as one might experience on a hot smoggy day, the extract of Luo Han Guo has a benefit for moistening and cooling the lungs, and is used for coughs, in cases of faucitis, tracheitis, bronchitis etc.

Said distinct and discrete regions may further respectively and selectively added by less than 2% by weight of flavors, for example, such as green tea flavor, honeysuckle flavor, jasmine flavor, mint flavor and the likes. The flavors are added to adjust the taste profiles and mouth feelings of said distinct and discrete regions of the confectionery product. For example, adding of honeysuckle flavor increases characteristic taste and smell of the product, and adding of mint flavors increases the cooling effect of the product. Likewise, said flavors can be added into one region or multiple regions of said distinct and discrete and discrete regions, the taste profiles and mouth feelings of the product is thus improved.

Other physiologically acceptable additives, such as coolant, colorant, tea powder, vitamin etc., can be added into one region or multiple regions of said distinct and discrete and discrete regions. Adding of coolant increase cooling effect of the product. Colorants can be selectively added into said distinct and discrete regions, so as to improve aesthetic aspect of the product to attract consumers. The tea powders and vitamin and other additives may improve nutrition and taste profiles of the confectionery product.

Preferably, the sweetener bases may be crystallized into small grain size by proper treatment process, so as to produce a final product with textures of different finenesses, texture with smaller grain size providing more fine and smooth mouth feeling. There are many types of treatment processes known in the art to make the texture of a sweetener base crystallized into small grain size, for example, crystal seeds can be added and mixed into a dissolved sweetener bases to help growing of small grains. Different sizes of crystal grains and different fineness of texture of the sweetener bases provide different mouth feeling of smoothness and fineness.

Now the present invention will be illustrated in details, by the way of example only and not limitation, through the following examples of confectionery products in according to embodiments of the invention.

| | | Example 1 | Example 2 | Example 3 |
|---|---|---|---|---|
| Content | | (%) | (%) | (%) |
| No. 1 | Isomalt | 47.45 | 42.70 | |
| region | Sorbitol | | | 34.90 |
| | Plant extracts | 0.10 | 6.08 | 6.00 |
| | Flavors | 1.00 | 0.02 | 0.30 |
| | Colorant | | | 0.001 |
| No. 2 | Xylito | 42.93 | 48.79 | 42.55 |
| region | Seeds of Xylito | 4.63 | | |
| | Plant extracts | | | 13.50 |
| | Flavors | 0.99 | 0.01 | 0.45 |
| | Colorant | 0.001 | 0.001 | |

| | | | |
|---|---|---|---|
| Moisture and others | 2.90 | 2.40 | 2.30 |

### EXAMPLE 1

In one preferred embodiment of the invention as illustrated in the above list, a hard candy comprises a first region containing 47.45% by weight of Isomalt, 0.10% by weight of extracts of plants, and 1.00% by weight of flavors, and a second region containing 47.56% by weight of Xylitol, 0.99% by weight of flavors and 0.001% by weight of colorant, and 2.90% by weight of moisture and other additives. Making process of the hard candy includes following steps: (1) first in a dissolving step, Isomalt and Xylitol are separatively dissolved to be prepared as base materials; (2) second in a mixing step, plant extracts and flavors are respectively added in and mixed with the Isomalt base, and the Xylitol base; (3) third in a forming step, firstly, a first region is formed with the Isomalt base, then a second region is formed with the Xylitol base and integrated with the first region on an upper/outer surface of the first region; (4) fourth in a cooling and crystallizing step, after a period of time, the bases of the first and second regions being formed in sequence are cooled and crystallized synchronously, and finally solidified to be an integrated hard candy.

In this example, the hard candy comprises two distinct and discrete regions including first and second regions of approximate equal size. The body portion of one hard candy comprises two distinct and discrete regions, which respectively have different mouth feelings and taste profiles due to the different chemical and physical properties of the different sweetener bases respectively contained in the first and second regions. The first region has a characteristic taste profile and nutrient value that different from that of the second region by adding plant extracts into the first regions. The first and second regions are respectively added with different flavors, which also increase the taste distinction between the two regions. Particularly, the second region is treated by adding crystal seeds of Xylitol to promote the growth of small crystal grain size, thereby the finenesses of the first and second regions are varied, so as to improve the mouth feeling. Besides, the colorant added in the second region to improve the aesthetic appearance of the product in order to attract consumers.

### EXAMPLE 2

In the example 2, another preferred embodiment of the confectionery product of the invention comprises a first region containing 42.70% by weight of Isomalt, 6.80% by weight of extracts of plants, and 0.02% by weight of flavors, and a second region containing 48.79% by weight of Xylitol, 0.01% by weight of flavors and 0.001% by weight of colorant, and 2.40% by weight of moisture and other additives. The Making process of the example 2 is similar to that of the example 1, however, the composition and taste profiles of the candy of the example 2 are different from that of the candy of the example 1.

### EXAMPLE 3

The example 3 shows yet another type of candy in according to one embodiment of the invention. The composition of the candy of the example 3 is different from the composition of the candies in example 1 and example 2. In this example, the candy comprises a first region containing 34.90% by weight of Sorbitol, 6.0% by weight of plant extracts, 0.03% by weight of flavors, and 0.001 by weight of colorant, a second region containing 42.55% by weight of Xylitol, 13.50% by weight of plant extracts, 0.45% by weight of flavors, and 2.30% by weight of moisture and other additives. The Making process of the example 3 is similar to that of the examples 1 and 2, however, the composition and taste profiles of the candy of the example 3 is different from that of the examples 1 and 2.

The confectionery product in according to the present invention may comprise more then two regions. For example, the confectionery products may include three regions consisting of two Xylito based regions and one Isomalt based region sandwiched there-between, or alternatively, containing three different sweetener bases, for example, Isomalt base, Xylito base and sorbitol base, or alternatively, any other combinations of three different sweeteners.

The confectionery product of the invention is formed with a multi-layer structure which may be formed in a stacked structure, or alternatively may be formed in a structure having multiple continuous coatings enclosing around a central core.

Overall, the present invention provides a confectionery product having a multi-layer structure, which comprises multiple distinct and discrete regions, each two adjacent regions respectively containing different sugar free sweetener bases. Different sweeteners respectively have different mouth feeling and taste profiles due to their different chemical and physical properties, therefore said distinct and discrete regions of the confectionery product provided multiple different taste profiles and mouth feelings to attract consumers.

What is claimed is:

1. A confectionery product comprising an integrated body portion, which includes at least two distinct and discrete regions, wherein said distinct and discrete regions respectively contain physiologically acceptable sweetener bases, each two adjacent regions respectively contain different sweetener bases, and at least one region of the sweetener bases essentially contains sugar free sweetener bases, wherein said distinct and discrete regions respectively have different crystal grain sizes, and crystal grain sizes of each two adjacent regions are distinctive, said distinct and discrete regions being adapted to provide multiple different taste profiles and mouth feelings.

2. The confectionery product as claimed in claim 1, wherein said sugar free sweetener base is selected from a group consisting of Isomalt, Xylito, Mannitol, Lactitol, Maltitol and Sorbitol.

3. The confectionery product as claimed in claim 2, wherein a first region of said distinct and discrete regions contains an Isomalt base, a second region of said distinct and discrete regions contains an Xylito base.

4. The confectionery product as claimed in claim 1, wherein said distinct and discrete regions respectively have different crystal grain sizes, and crystal grain sizes of each two adjacent regions are distinctive.

5. The confectionery product as claimed in claim 1, wherein said distinct and discrete regions respectively and selectively contains less than 20% by weight of plant extracts, less than 2% by weight of physiologically acceptable flavors, and physiologically acceptable colorants.

6. The confectionery product as claimed in claim 4, wherein said distinct and discrete regions respectively and selectively contains less than 20% by weight of plant extracts, less than 2% by weight of physiologically acceptable flavors, and physiologically acceptable colorants.

7. The confectionery product as claimed in claim 1, wherein the confectionery product is formed in a stacked structure.

8. The confectionery product as claimed in claim 1, wherein the confectionery product is formed in a structure having continuous coatings enclosing around a central core.

9. The confectionery product as claimed in claim 4, wherein the confectionery product is formed in a stacked structure.

10. The confectionery product as claimed in claim 4, wherein the confectionery product is formed in a structure having continuous coatings enclosing around a central core.

11. The confectionery product as claimed in claim 5, wherein the confectionery product is formed in a stacked structure.

12. The confectionery product as claimed in claim 5, wherein the confectionery product is formed in a structure having continuous coatings enclosing around a central core.

13. The confectionery product as claimed in claim 6, wherein the confectionery product is formed in a stacked structure.

14. The confectionery product as claimed in claim 6, wherein the confectionery product is formed in a structure having continuous coatings enclosing around a central core.

15. The confectionery product as claimed in claim 2, wherein said distinct and discrete regions respectively have different crystal grain sizes, and crystal grain sizes of each two adjacent regions are distinctive.

16. The confectionery product as claimed in claim 3, wherein said distinct and discrete regions respectively have different crystal grain sizes, and crystal grain sizes of each two adjacent regions are distinctive.

17. The confectionery product as claimed in claim 2, wherein said distinct and discrete regions respectively and selectively contains less than 20% by weight of plant extracts, less than 2% by weight of physiologically acceptable flavors, and physiologically acceptable colorants.

18. The confectionery product as claimed in claim 3, wherein said distinct and discrete regions respectively and selectively contains less than 20% by weight of plant extracts, less than 2% by weight of physiologically acceptable flavors, and physiologically acceptable colorants.

19. The confectionery product as claimed in claim 2, wherein the confectionery product is formed in a stacked structure.

20. The confectionery product as claimed in claim 3, wherein the confectionery product is formed in a stacked structure.

21. The confectionery product as claimed in claim 2, wherein the confectionery product is formed in a structure having continuous coatings enclosing around a central core.

22. The confectionery product as claimed in claim 3, wherein the confectionery product is formed in a structure having continuous coatings enclosing around a central core.
